(19) United States
(12) Patent Application Publication
(10) Pub. No.: US 2024/0409767 A1
(43) Pub. Date: Dec. 12, 2024

(54) A MULTILAYER VARNISHED SURFACE, A METHOD OF PRODUCING A MULTILAYER VARNISHED SURFACE AND A FURNITURE PRODUCT CONTAINING SUCH A SURFACE

(71) Applicant: SCHATTDECOR SP. Z.O.O., Tarnowo Podgórne (PL)

(72) Inventors: Jerzy SZEJWIAN, Tarnowo Podgórne (PL); Michal SMUS, Tarnowo Podgórne (PL); Krzysztof KONIECZNY, Tarnowo Podgórne (PL)

(21) Appl. No.: 18/704,171

(22) PCT Filed: Oct. 18, 2022
(86) PCT No.: PCT/PL2022/050066

§ 371 Date: Apr. 24, 2024

(30) Foreign Application Priority Data
Oct. 27, 2021 (PL) P.439325

(51) Int. Cl. C09D 133/12; C08J 7/04; C09D 7/42; C09D 7/61

(52) U.S. Cl. CPC C09D 133/12; C08J 7/042; C09D 7/42; C09D 7/61; C08J 2433/12

(57) ABSTRACT

The invention relates to a multilayer coated decorative surface that is free from formaldehyde emissions. The surface consists of a carrier layer 1 and a first varnish layer 2 and a second varnish layer 3, while the varnish in the first varnish layer 2 and the second varnish layer 3 contains an acrylate compound and a reactive diluent monomer. The varnish in the first varnish layer 2 with a thickness ranging from 2 to 10 μm further comprises at least one matting agent and at least one dispersed pigment, and the first varnish layer 2 is applied directly to the carrier layer 1 and it covers the entire surface of the carrier layer 1, and the second varnish layer 3 with a thickness ranging from 2 to 10 μm is applied directly to the first varnish layer 2 and it covers the entire surface of the first varnish layer 2.

The invention also relates to a method for obtaining such a surface.

The surface according to the invention is used as an outer layer of furniture boards.

The subject of the invention is a multilayer varnished surface on carriers such as paper or artificial films, in particular biaxially oriented polypropylene BoPP, cast non-oriented polypropylene cPP, PVC, PET, and containing a transparent varnish layer that can be cured with electron beab or UV radiation. The subject of the invention is also a method of producing such a multilayer varnished surface and a furniture product comprising a multilayer varnished surface.

Multilayer coated surfaces as used decorative materials and methods for producing such surfaces are known in the art.

Known coated surfaces are usually obtained from an aqueous varnish layer with an addition of acid prior to application to accelerate the curing process. This layer is then covered with a topcoat of varnish which is then electron beam or UV cured. However, the aqueous varnish with an addition of acid to accelerate the curing process of the solid particles of the resins, also contains melamine-formaldehyde resins in amounts from 15 to 45%, which bind the varnish, but at the same time cause formaldehyde emissions from such surfaces. Formaldehyde is a colourless gas with a strong, characteristic odour that can be found in our natural environment. Formaldehyde decomposes under the action of sunlight, metabolic processes and the action of bacteria present in soil or water. It can be emitted into the air by a number of materials such as chipboards, fibreboards, wooden panels, sandwich panels, adhesives, paints and varnishes, mainly those used for wood. Formaldehyde is a toxic, harmful, corrosive or irritating substance depending on the concentration.

The invention U.S. Pat. No. 4,942,198A discloses such aqueous varnishes containing blocked acid resins, polyacrylate and melamine resins or melamine urea resins. These varnishes are cured by heat treatment, while the acid acts as a catalyst in the curing process. Although mention is made of keeping the level of formaldehyde low, the varnishes disclosed in the invention U.S. Pat. No. 4,942,198A still emit formaldehyde because its source, the melamine urea resins, are is still present in the varnish composition and formaldehyde is released during the heat treatment of the varnish.

Likewise, invention U.S. Pat. No. 4,940,841A mentions varnishes that can be used on decorative surfaces including polyacrylate, melamine resin, urea resin, polyol and amine. The varnishes used contain sources of formaldehyde, melamine and urea resins, which is why the emission of formaldehyde is not prevented.

Document P.426181 discloses a multilayer coated surface and a method for producing such surfaces. The multilayer surfaces in the said document P.426181 comprise a carrier layer, a printed decor layer, a priming layer and varnish layers.

The last varnish layer that forms the structure, however, does not completely cover the surface, but rather copies the printed decor. Moreover, document P.426181 discloses a method of producing said multilayer decorative surfaces. The method consists in applying a decor to the carrier layer, then applying a primer to it, and then applying varnishes that can be cured with an electron beam. Matt surfaces are obtained by means of excimer radiation.

Thus, the present invention aims to reduce or eliminate the emission of formaldehyde from decorative surfaces by eliminating aqueous varnishes in which acid is added prior to application, while ensuring the chemical and mechanical resistance of the new decorative surfaces. To achieve this goal, the multilayer coated surface of the present invention uses formaldehyde-free coatings as varnishes. In the present invention, the sources of formaldehyde, such as acid-cured varnishes and melamine-formaldehyde resins, are not used.

Multilayered varnished surface, consisting of:
a) layer made of a material based on paper or polymer film,
b) first coat of varnish, and
c) second layer of varnish, while the varnish in the first and second varnish layers contain an acrylate compound and a reactive diluent monomer,
   It is characterized by the fact that the varnish in the first varnish layer with a thickness ranging from 2 to 10 μm contains at least one matting agent and at least one dispersed pigment, and the first varnish layer is applied directly to the carrier layer and it covers the entire surface of the carrier layer, and the second varnish layer is applied directly to the first varnish layer and it covers the entire surface of the first varnish layer.

Preferably the polymer film is BoPP, cPP, PVC or PET, and the paper is impregnated paper.

It is also preferred that the second varnish layer comprises a matting agent.

It is also preferred that the matting agent is titanium dioxide TiO₂.

It is also preferred that the second varnish layer contains an adhesion promoter.

The multilayer surface consists of a carrier layer 1, a first varnish layer 2 and a second varnish layer 3. The carrier layer 1 is made of a material based on paper or a polymer film. The polymer film is selected from the group consisting of BoPP, cPP, PVC and PET. When the carrier layer 1 is paper, the paper can be impregnated.

The first varnish layer 2 is applied directly to the surface of the carrier layer 1 and covers the entire surface of the carrier layer 1. The first varnish layer 2 has a thickness ranging from 2 to 10 μm. This layer determines the final colour appearance of the product, and is also a key ingredient in obtaining chemical resistance on the decorative surface. However, a single varnish layer does not achieve the level of mechanical resistance expected in the furniture industry. Increased sensitivity to the metal abrasion test is observed when only one varnish layer is present on the decorative surfaces. For this reason, another coat of varnish should be applied to improve the abrasion resistance.

The second layer, applied directly on the entire surface of the first layer, is a coating of transparent electron beam cured varnish, with a thickness in the range of 2-10 μm. The systems of application of this varnish layer that are currently in use allow for obtaining the optimal surface characteristics in terms of homogeneity and gloss, which is of particular importance in the final visual assessment of the product.

The varnish in the first varnish layer comprises an acrylate compound, a reactive diluent monomer, at least one matting agent and at least one pigment. Acrylic resins bind solid substances (fillers, pigments), creating an even coating and they are responsible for adhesion to the substrate, affect the gloss and transparency of the coating. The reactive diluent monomer has a low molecular weight and a low viscosity. Monomers do not evaporate from the coating and take part in a chemical reaction (ie. they create a coating). The pigment used in the varnish causes the decorative surface to have one uniform colour, without the need to apply an additional decorative layer. Moreover, since no additional decorative layer is required, the resulting multilayer surface is economical to manufacture. When the matting agent is TiO₂, it can also act as a white pigment. Such varnish is formaldehyde-free and therefore does not emit formaldehyde.

The method of obtaining a multilayer varnished surface includes these steps:
a) provide a carrier layer made of a material based on paper or polymer film,
b) cover the entire surface of the carrier layer with the first varnish layer containing matting agent,
c) expose the applied first varnish layer to an electron beam radiation at a dose of 2-6 kGy or UV radiation with an adequate dose,
d) cover the entire surface with a second varnish layer,
e) expose the applied second varnish layer to an electron beam radiation with a dose of at least 35 kGy or UV radiation with an adequate dose,

Preferably, before curing in step e), the applied clear varnish layer is subjected to an excimer lamp radiation at a wavelength of 172 nm.

The coating of steps b) and d) can be carried out by any method known in the art. The 3WS and DKR application methods and flexographic coating are preferred. It is advantageous when both methods are combined, i.e. when the first varnish layer is applied with the 3WS coating system and the second varnish layer is applied with the flexographic coating system, or when the first varnish layer is applied with the 3WS coating system and the second varnish layer 3 is applied with the DKR coating system

The electron beam curing treatment performed in step c) with a dose in the range of 2-6 kGy does not cause complete polymerization of the applied first layer of varnish, rather it causes pre-polymerization, i.e. gelling and allows the next layer to be applied and obtain adequate adhesion between the next layer and the first layer of varnish applied.

The electron beam curing carried out in step e) with a dose of 35 kGy causes complete polymerization of the surface. As a result of this treatment, the second varnish layer is completely cured.

The production process is based on a varnishing or printing-varnishing machine. The blank roll is placed in the unwind section. The web advances to the first varnish layer coating section by means of a series of guide rollers. The application takes place at the contact point of the substrate and the roller applying the varnish. The second coat of varnish is applied in the same way in the next varnishing system. After applying two layers of varnish and curing them properly, the web advances to the winding section. The product is ready for further processing in furniture systems.

The essence of the solution is also a furniture product with a multilayer varnished surface described above.

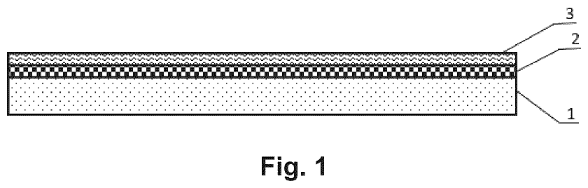

The subject of the invention is presented in more detail in FIG. 1, where item 1 is the carrier layer, 2 is the electron beam cured pigment varnish layer, and 3 is the electron beam cured transparent varnish layer.

All Schattdecor varnishes used in the following examples contain matting agents:
71-83.0
40%—TiO₂
71-83.4
40%—TiO₂
0.26%—flame silica (pyro)
70-92.1
1.5%—amorphous, synthetic silica (3.4-4.0 μm)
31%—PMMA
70-92.10
0.2%—pyrogenic silica—used as a delamination preventing agent

On the other hand, Hesse varnishes are available on the market with the composition declared by the manufacturer.

For the excimer lamps used, the standard neutralization level in the chamber with these lamps during production is 50-200 ppm.

The empirically conducted varnishing tests allowed us to obtain a coating with a thickness between 8-20 μm resistant to mechanical and chemical testing.

### EXAMPLE 1—ONLINE COATING OF TWO LAYERS—TWO 3WS SYSTEMS

The base roller in the form of a semi-finished product which is smooth impregnated paper, the so-called vorimpregnate, is placed in the unwinding section of the machine.

A first varnish layer 2, which is an electron bean cured pigment varnish, is applied to this carrier layer 1. At this stage of the process, the coat has the following composition:
Schattdecor 71 varnish—83.4-0.5 parts
Schattdecor 71 varnish—83.0-0.5 parts

Coating takes place in the 3WS system. The carrier is covered evenly over the entire surface with a layer 7 μm thick. The layer undergoes initial polymerization (gelling) in the electron beam generator. The generator parameter settings are as follows:
radiation dose—5 kGy
High voltage—110 kV

The applied layer has a surface gloss of 19° when measured in the 60° geometry.

The coated material then moves to a second 3WS coating station and a second coat of varnish 3 is applied. The composition of the second varnish layer 3 is as follows:
Schattdecor 70 varnish—92.10-0.8 parts
Schattdecor 70 varnish—92.1-0.2 parts

The resulting coating is fully electron beam cured in the generator. The device settings are as follows:
radiation dose—35 kGy
High voltage—110 kV

The finished product has a surface with a gloss of 26° measured in a 60° geometry and a total coating thickness of 15 μm±1 μm.

The obtained decorative surface is characterized by a uniform colour, which is guaranteed by the composition of the varnish from the first layer 2, as well as chemical and mechanical resistance, adapted to the requirements of the furniture industry. Moreover, both varnish layers are formaldehyde-free, which additionally makes the product more attractive. The condition for good bonding of both varnish layers is the initial gelling of the first varnish layer.

FIG. 1 depicts the cross-section of the substrate with the varnish layers.

### EXAMPLE 2—TWO ONLINE LAYERS—FIRST LAYER IN 3WS SYSTEM—SECOND LAYER IN FLEXOGRAPHIC SYSTEM, COATING REFINED WITH EXCIMER LAMP EXPOSURE

The carrier layer 1, the method of applying and curing the first varnish layer 2 thereon is the same as in example 1. The gelled first varnish layer 2 evenly covers the entire web of impregnated paper and advances to the second flexographic coating station.

The system application roller applies a layer of transparent electron beam cured varnish composed of:
Hesse FL 27692 varnish—0.9 parts
Hesse FL 27800 varnish—0.08 parts
Scratch-resistant additive—Hesse FZ 2711-0.05 parts
Varnish adhesion enhancing additive—Hesse FL 2720-0.015 parts.

The applied layer first advances through the surface refinement chamber using excimer lamps, which allows to obtain a matte varnish coating. Then, the moving web passes through the chamber of the electron beam generator, where both layers of varnish are finally cured, creating a ready material for further furniture processing. Parameters of the electron beam generator during the final curing of the varnish layers:
radiation dose—35 kGy
High voltage—110 kV

The product surface is characterized by a coating with a gloss in the range of 8°-10° when measured with a geometry of 60° and a thickness of 14 μm±1 μm.

The condition for a good bonding of both layers of varnish is initial gelling of the first varnish layer and the addition of an adhesion-enhancing agent in the second varnish layer.

The resulting film and its cross section is disclosed in FIG. 1.

### EXAMPLE 3—TWO ONLINE LAYERS—TWO 3WS SYSTEMS—SECOND LAYER REFINED WITH EXCIMER LAMP EXPOSURE

The carrier layer 1, the method of applying and curing the first varnish layer 2 thereon is the same as in example 1. The gelled first varnish layer 2 evenly covers the entire web of impregnated paper and advances to the second coating station with a 3WS roller.

At this stage, the web is covered with a layer of transparent electron beam cured varnish with the following composition:
Hesse FL 27692 varnish—0.5 parts
Hesse FL 27800 varnish—0.48 parts
Scratch-resistant additive—Hesse FZ 2711-0.05 parts
Varnish adhesion enhancing additive—Hesse FL 2720-0.15 parts.

The applied layer first advances through the surface refinement chamber using excimer lamps, which allows to obtain a matte varnish coating. Then, the advancing web passes through the electron beam generator chamber, where both layers of varnish are finally cured, thus creating a finished product for further processing in the furniture surface refining processes.

Parameters of the electron beam generator during the final curing of the varnish layers:
radiation dose—35 kGy
High voltage—110 kV

The surface of the finished material is characterized by a coating with a gloss of 6° measured with a geometry of 60° and a thickness of 16 μm±1 μm.

The decorative material obtained in this way can be successfully used for application of veneer on kitchen fronts or other furniture surfaces. The matte finish made in this example complements the range of standard single-colour high-gloss surfaces.

The condition for a good bonding of both layers of varnish is initial gelling of the first varnish layer 2 and the addition of an adhesion-enhancing agent in the second varnish layer 3.

The resulting film and its cross section is disclosed in FIG. 1.

### EXAMPLE 4—TWO ONLINE LAYERS—TWO 3WS SYSTEMS—SYNTHETIC FILM AS A CARRIER

Unlike examples 1 and 2 or 3, the substrate to be coated on the two layers of varnish is a polypropylene or polyethylene synthetic film. Good properties for further processing in furniture applications are obtained by using polypropylene and polyethylene film.

All coating and refinement processes can be repeated in this example based on the processes of examples 1, 2 or 3.

The obtained surfaces are materials for furniture applications, in various areas of application, especially where it is appropriate to use single-colour decorative effects and application of a substrate in the form of a synthetic film is required.

As in the examples 1, 2 or 3 above, the condition for bonding both layers of varnish is to initially gel the first layer, before applying the second layer.

FIG. 1 shows a cross-section of a product according to the principles of the invention.

### EXAMPLE 5—OFFLINE COATING OF TWO LAYERS—DKR+3WS

On the carrier, as in example 1, the first layer of electron bean cured pigment varnish is applied by means of a DKR roller coating station. This process allows to obtain a coating, varnish of the following composition:
Schattdecor 71 varnish—83.4-0.5 parts
Schattdecor 71 varnish—83.0-0.5 parts

The applied layer with a thickness of 8 μm is partially polymerized (gelled) by radiation from the electron beam generator. Partial polymerization is described by the device settings:
radiation dose—5 kGy
High voltage—110 kV

After this stage of the process, a varnish coated web is obtained with a visual effect of a uniform colour with a gloss of 18° when measured in a geometry of 60°. The web is wound up on a roller, secured and prepared for the next coating process on a different machine.

In order for the product to meet the requirements of chemical and mechanical resistance, a second stage of varnish coating is necessary, which may take place on a different varnishing machine or at a different time on the same machine, but with a different configuration of the varnish coat application process. For this reason, the example is referred to as offline coating, which means that the finished product is obtained by two passes of the substrate through the coating machine.

The second varnishing process is carried out using the 3WS coating station. At this stage, a layer of transparent electron beam cured varnish is applied. The varnish has the following composition:
Schattdecor 70 varnish—92.10-0.8 parts
Schattdecor 70 varnish—92.1-0.2 parts

The obtained coating is completely cured with an electron beam in the generator. The device settings are as follows:
radiation dose—35 kGy
High voltage—110 kV

The decorative surface has a 25° gloss coating when measured with a geometry of 60°. The coated web is characterized by a total thickness of the varnish coat of about 17 μm±1 μm and a homogeneous single-colour decorative effect.

The condition for good bonding of both varnish layers is the initial gelling of the first varnish layer.

FIG. 1 shows a cross-section of the decorative product.

The results for the surfaces obtained in the above examples—Martindale mechanical resistance test, R2 chemical resistance test.

| | | R2 | | | |
|---|---|---|---|---|---|
| | | water | paraffin | ethanol | coffee |
| Example | Martindale | 24 h | 24 h | 48% 1 h | 1 h |
| 1 | 5 | 5 | 5 | 5 | 5 |
| 2 | 4 | 4 | 5 | 5 | 5 |
| 3 | 4 | 5 | 5 | 5 | 5 |
| 4 | 4 | 4 | 5 | 5 | 5 |
| 5 | 4 | 4 | 5 | 5 | 5 |

1. Multilayered varnished surface, consisting of:
a) Carrier layer 1, made of a material based on paper or polymer film,
b) first varnish layer 2, and
c) second varnish layer 3, while the varnish in the first and second varnish layers contain an acrylate compound and a reactive diluent monomer,
characterized in that
The varnish in the first varnish layer 2 with a thickness ranging from 2 to 10 μm further comprises at least one matting agent and at least one dispersed pigment, and the first varnish layer 2 is applied directly to the carrier layer 1 and it covers the entire surface of the carrier layer 1, and the second varnish layer 3 with a thickness ranging from 2 to 10 μm is applied directly to the first varnish layer 2 and it covers the entire surface of the first varnish layer 2.

2. A multilayer varnished surface according to claim 1, characterized in that the polymer film is BoPP, cPP, PVC or PET.

3. A multilayer varnished surface according to claim 1, characterized in that the second varnish layer 3 comprises a matting agent.

4. A multilayer varnished surface according to claim 1, characterized in that the matting agent is titanium dioxide TiO₂.

5. A multilayer varnished surface according to claim 1, characterized in that the second varnish layer 3 contains an adhesion-enhancing additive.

6. The method of obtaining a multilayer varnished surface, characterized in that it comprises the following steps:
a) provide a carrier layer 1 made of a material based on paper or polymer film,
b) cover the entire surface of the carrier layer 1 with the first varnish layer 2 containing matting agent,
c) expose the applied first varnish layer 2 to an electron beam radiation at a dose of 2-6 kGy or UV radiation with an adequate dose,
d) cover the entire surface with a second varnish layer 3,
e) expose the applied second varnish layer 3 to an electron beam radiation with a dose of at least 35 kGy or UV radiation with an adequate dose,

7. The method according to claim 5, characterized in that, before curing in step e), the applied transparent varnish layer (3) is subjected to an excimer lamp at a wavelength of 172 nm.

8. Furniture product comprising a multilayer varnished surface according to claim 1.
